(19) United States
(12) Patent Application Publication
(10) Pub. No.: US 2008/0303355 A1
(43) Pub. Date: Dec. 11, 2008

(54) Rail motor system and method

(76) Inventors: Orlo James Fiske, Goleta, CA (US); Michael Richard Ricci, Camarillo, CA (US)

Correspondence Address: MARK RODGERS, 1590 SAN ROQUE ROAD, SANTA BARBARA, CA, 93105, US

(21) Appl. No.: 12/077,087

(22) Filed: Mar. 13, 2008

Related U.S. Application Data
(60) Provisional application No. 60/895,370, filed on Mar. 16, 2007.

(51) Int. Cl. H02K 41/02

(52) U.S. Cl. 310/12

(57) ABSTRACT

A variable reluctance electric motor employs motor coils installed adjacent to or integral with railroad rails and uses the steel wheels of railroad locomotives and cars as its moving elements. This “rail motor” electrically propels unmodified conventional railroad trains or individual railroad cars, without the use of diesel engines and with no mechanical connection to the vehicles, and is electronically controlled. Electric operation eliminates the production of air pollution by any locomotive traveling through rail motor-equipped zones, improves system capacity by providing boost power on ascending grades, and can be used to brake trains, recovering and storing the energy.

### CROSS-REFERENCE TO RELATED PATENT APPLICATIONS

Embodiments of the present invention relate to U.S. Provisional Application No. 60/895,370 filed Mar. 16, 2007, entitled “The Rail Motor”, the contents of which are incorporated by reference herein and which is a basis for a claim of priority in the current application.

### BACKGROUND OF THE INVENTION

1. Field of the Invention

The present invention relates, generally, to linear electric motors and electric propulsion of steel-wheeled railroad vehicles.

2. Background of the Disclosure

Air pollution resulting from diesel railroad operations in or near urban areas has become a critical problem, with a huge impact on the health of the surrounding population. Health care costs resulting from low air quality exceed $10 billion per year in California alone. Recent efforts to clean up diesel engines used in ships, locomotives, trucks and off-road equipment have produced significant improvements, but in some areas with dense populations the rapidly growing volume of international trade shipments threatens to overwhelm these efforts and drive air quality even lower. Clearly, achieving acceptable levels of air quality will require more than just cleaner diesels. Powering vehicles with electricity from the grid could remove local sources of air pollution entirely, but if this is to be commercially viable it cannot adversely impact freight throughput. In many regions where diesel locomotives are the primary motive power for railroads, electric line-haul locomotives are not viewed as an acceptable option due to the difficulty, expense and safety impact of installing catenary lines or live rails.

The situation is not without hope, however. A relatively short separation between the source of pollution (diesel engines) and populated areas makes a large difference in concentration of pollutants in the air, and the resulting health effects. This distance could be achieved through the use of hybrid diesel/electric locomotives if they could provide purely electric (engine off) propulsion in nonattainment areas. This would allow a large fraction of the freight arriving through ports, such as Los Angeles and Long Beach in California, or passing through urban areas to proceed without the production of air pollution. Two problems prevent this: (1) energy storage is currently not adequate to power line-haul locomotives for any significant length of time; and (2) diesel locomotives have an operational lifetime of 30-40 years, so even if an adequate electricity storage technology were discovered today, it would take 30+ years to replace all the locomotives in use in the United States. We cannot afford to wait that long.

A potential alternative to hybrid locomotives is electric propulsion provided by a linear electric motor, such as a Linear Induction Motor (LIM), installed in the track. In this approach, motor windings in the track create a moving magnetic field that interacts with a conductive reaction plate in the vehicle to provide thrust. The reaction plate is problematic, however. In order for this system to work, a large aluminum or copper plate must be installed in the undercarriage of every railroad vehicle passing through the “electric-only” zone. There are over 23,000 locomotives and over a million freight cars in service in the U.S., and it is clearly not feasible to retrofit them all. On the other hand, it would be impossible to mount reaction plates on the thousands of vehicles per day that enter some potential electric zones, and remove the plates as they leave those zones, without radically reducing the traffic capacity of the railroad system. With the system now operating at near its maximum capacity, such a slowdown is not feasible.

It would be far more useful if a system could be created that would electrically propel standard, unmodified diesel railroad trains through critical zones with their locomotive engines shut down. This would permit the vast inventory of existing railroad equipment to remain in service for its full useful lifetime, while eliminating diesel emissions from sensitive areas.

### SUMMARY OF THE DISCLOSURE

The invention is at least one linear variable reluctance motor arranged along a pathway and a rotating ferromagnetic element constrained to roll down the pathway about an axle. The array of controlled electromagnetic elements is sequentially actuated to impart a force at least partially tangential to the rotating element in such a way as to induce rotation about the axle. In a specific example described in detail, a railway, a variable reluctance electric motor employs motor coils installed adjacent to or integral with railroad rails which constitute the pathway, and uses the steel wheels of railroad vehicles, such as locomotives and cars as its rotating ferromagnetic elements. This “rail motor” electrically propels unmodified conventional railroad trains or individual railroad cars, without the use of diesel engines and with no mechanical connection to the vehicles, and is electronically controlled. Electric operation eliminates the production of air pollution by any locomotive traveling through rail motor-equipped zones, improves system capacity by providing boost power on ascending grades, and can be used to brake trains, recovering and storing the energy. Various embodiments directed to the railway example are disclosed herein.

These and other aspects and advantages of embodiments of the present invention will become apparent from the following detailed description and the accompanying drawings in which various embodiments of the present invention are shown by way of illustrative example. Although the specific examples of railway implementations of the invention are preferred embodiments, it should be understood that the scope of the invention is meant to include any application of the novel use of a linear variable reluctance motor coupled to ferromagnetic rotating elements.

### BRIEF DESCRIPTION OF THE DRAWINGS

FIG. 1 (prior art) shows a cross-section of a Variable Reluctance motor.

FIG. 2 (prior art) illustrates the general structure and operation of a linear Variable Reluctance motor.

FIG. 3a is a top view of the basic structure of the first embodiment of a rail motor according to the present invention.

FIG. 3b is a side view of the basic structure of the first embodiment of a rail motor according to the present invention.

FIG. 3c is a side view an “E”-core embodiment of a rail motor.

FIG. 3d is a perspective view of an E-core for use in a rail motor.

FIG. 4 is an end view of railroad wheels on a standard track with rail motors according to another embodiment of the present invention.

FIG. 5a is an end view of railroad wheels on a modified track with integral rail motors according to another embodiment of the present invention.

FIG. 5b is a side view of the track with integral rail motor as shown in FIG. 5a.

FIG. 5c is a close-up side view of part of the modified track of FIG. 5a.

FIG. 6a shows a cross section of a modified track with integral rail motor according to another embodiment of the present invention.

FIG. 6b is a top view of the track and rail motor of FIG. 6a.

### DETAILED DESCRIPTION OF THE PREFERRED EMBODIMENTS

The following detailed description is not to be taken in a limiting sense, but is made merely for the purpose of illustrating the general principles and various embodiments of the invention. The specific example of the invention applied to a railway is used since solving that particular problem was an impetus for the invention, but the railway implementation is exemplary. Designs for causing rotation in an element in the manner according to the invention will suggest themselves to those skilled in the art in a variety of applications.

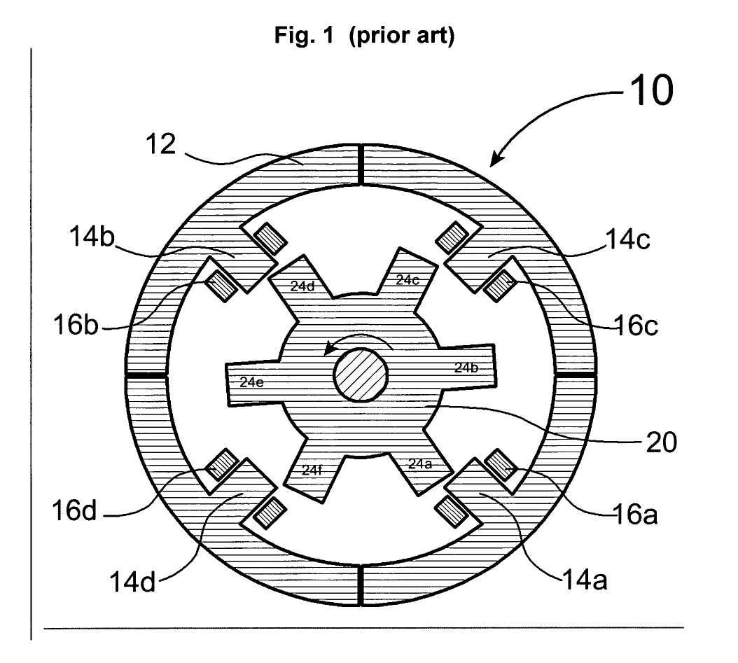

Variable Reluctance (VR) motors, also known as Switched Reluctance motors, operate on the principle that a magnetically salient rotor will move to a position of minimum reluctance to the flow of flux in a magnetic circuit. FIG. 1 (prior art) shows a cross-sectional view of a conventional rotary VR motor 10. This particular example includes an iron rotor 20 with six outward-pointing salient poles 24a, b, c, d, e and f. The rotor is enclosed by an iron stator 12 with four inward-pointing salient poles 14a, b, c and d wrapped by electromagnet coils 16a, b, c, and d. The electromagnets are provided with current, in a sequence directed by an electronic control system (not shown), such that their excitation attracts the nearest rotor pole, turning the wheel in the desired direction. For example, with the rotor position shown in FIG. 1, activating coils 16a and 16b will attract rotor poles 24a and 24d, respectively, and cause the rotor to turn in a counter-clockwise direction. As pole 24a aligns with poles 14a and pole 24d aligns with pole 14b, current to coils 16a and 16b is shut off. Current is then activated in coils 16c and 16d, which causes stator poles 14c and 14d to attract rotor poles 24b and 24e, and so on. The simple brushless construction of the motor makes it cheap to build and reliable in operation. The unipolar current requirements of the coil windings result in a simple and very reliable power converter circuit.

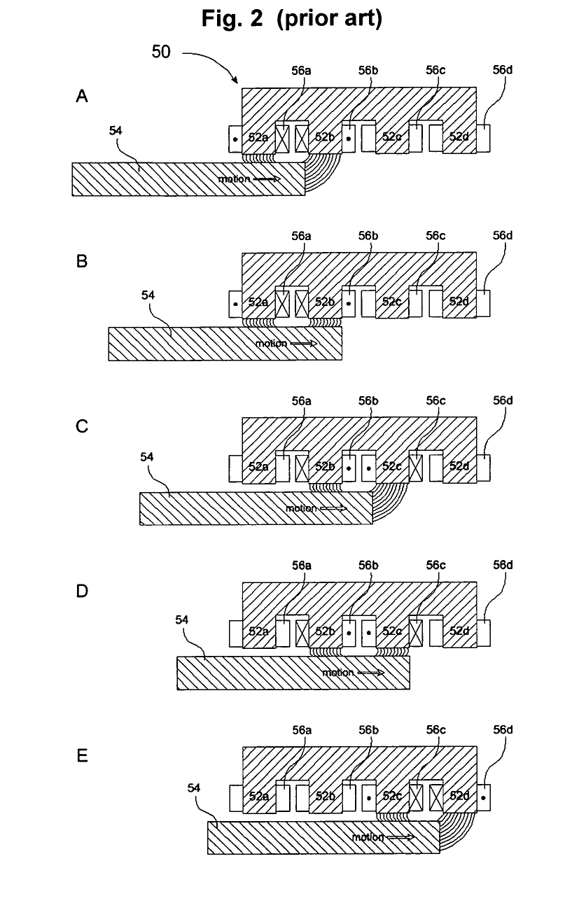

VR motors may also be built in linear configurations, as shown in FIG. 2. In this example linear VR motor 50 includes four drive coils 56a, b, c and d mounted on poles 52a, b, c and d of an iron stator. The moving element 54 of the motor is an iron plate, constrained by bearings or rails to motion along a straight line. In FIG. 2A, coils 52a and 52b are energized with opposite polarity, forming a flux loop that attracts plate 54 and pulls it to the right. When plate 54 reaches the position shown in FIG. 2B, where force I the direction of motion drops to zero, coil 52a is de-energized and coil 52c is energized, as shown in FIG. 2C. Plate 54 is again pulled to the right until it reaches the position shown in FIG. 2D. Coil 52b is then shut down and coil 52d is energized, as shown in FIG. 2E, and so on.

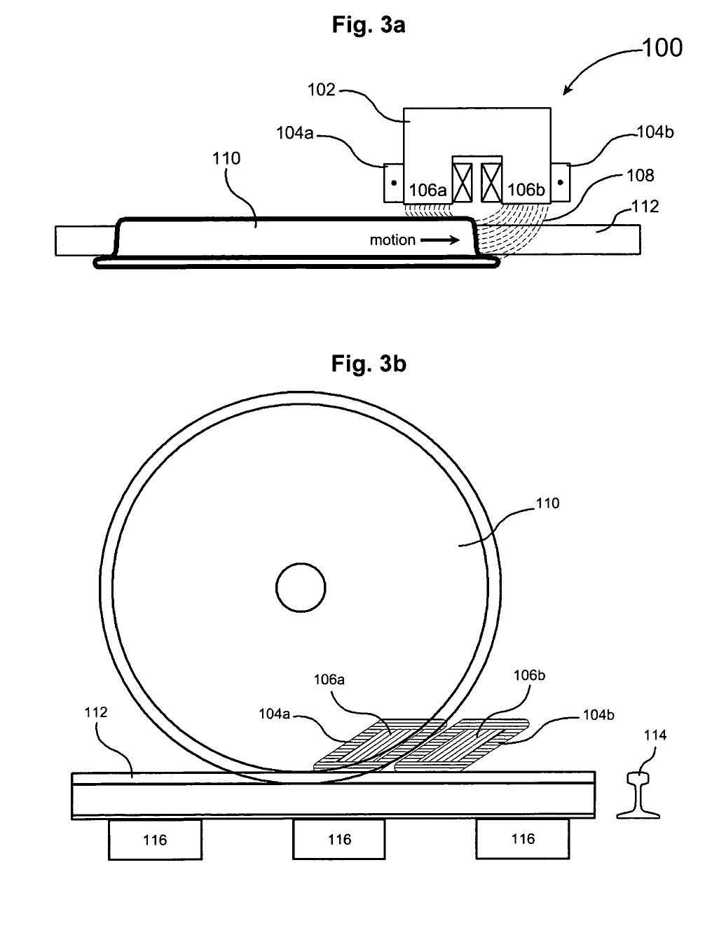

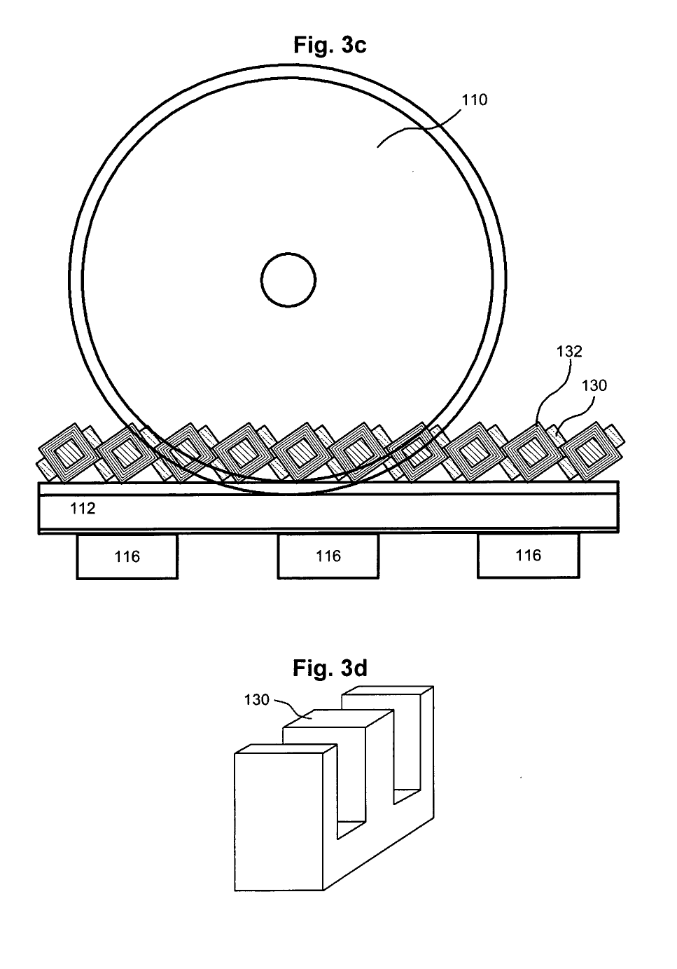

FIG. 3a is a top view of the basic structure of a variable reluctance rail motor 100, according to an embodiment of the present invention. Motor stator 102, typically fabricated of laminated iron, is mounted next to railroad rail 112, of conventional design. Motor coils 104a and b are wrapped around stator poles 106a and b. Stator 102 is shown with only two poles for clarity, but typically would have many sequential poles, each wrapped with a motor coil. As steel railroad wheel 110 reaches a position adjacent to pole 106a, as shown, current is activated in coils 104a and b, creating a magnetic field that acts to pull wheel 110 forward (to the right) to minimize reluctance in the magnetic circuit. In other words, the rail motor produces thrust and the wheel rolls forward. In this and other embodiments, the driving tangential force on the wheel is substantially in the forward (or backward direction) of the track

FIG. 3b shows a side view of the rail motor of FIG. 3a. Rail 112 is mounted on railroad ties 116. Profile 114 shows the conventional cross-sectional shape of rail 112. Rail motor poles 106a and b are tilted to the right to approximate the angle of the leading edge of railroad wheel 110 so as to provide maximum magnetic coupling between the wheel and the pole for wheel motion toward the right. In other embodiments the motor poles could be vertical, as shown in FIG. 3d, to best allow wheel motion in either direction, tilted to the left for leftward motion, or otherwise shaped to optimize coupling for particular applications. Motor coils 104a and b are wrapped tightly around poles 106a and b. In a typical installation, the rail motor would extend continuously or intermittently from one end to the other of the track zone to be electrified.

FIG. 3c shows a side view of a rail motor embodiment in which the motor cores are “E” shaped. One such core is shown in perspective view in FIG. 3d. In this design magnetic flux produced by motor coil 132 travels from the center pole of E-core 130, through wheel 110 and back to the end poles of E-core 130 to complete the loops. Thus each E-core attracts wheel 110 by itself. Again, the E-cores are shown tilted, but could be straight or otherwise shaped to optimize magnetic coupling.

To confirm operational effectiveness, Finite Element Analysis was performed on the basic rail motor design of FIG. 3a. A 3D FEA model included a steel wheel and steel rail of conventional design, and a rail motor stator mounted on one side of the rail with 0.75″ gap between the stator pole and the wheel flange surface. This basic, un-optimized design with simple rectangular poles produced 385 Newtons of thrust.

When operated out of phase with wheel position, the rail motor can provide braking force rather than acceleration. For example, in FIG. 3a if wheel 110 is assumed to be moving to the left, rather than the right, the attractive force provided by rail motor 100 will act to decelerate the wheel. By varying the phase of the current applied to the rail motor, negative or positive thrust (relative to the vehicle direction of motion) can be created, which will put energy into the wheel (positive thrust) or extract energy from the wheel (negative thrust). Extracting power from the wheel will have the effect of converting the vehicle's kinetic energy into useful electric power. Electricity produced by this “regenerative braking” can be stored in a battery, for example, for later reuse, thereby increasing the energy efficiency of the railroad system.

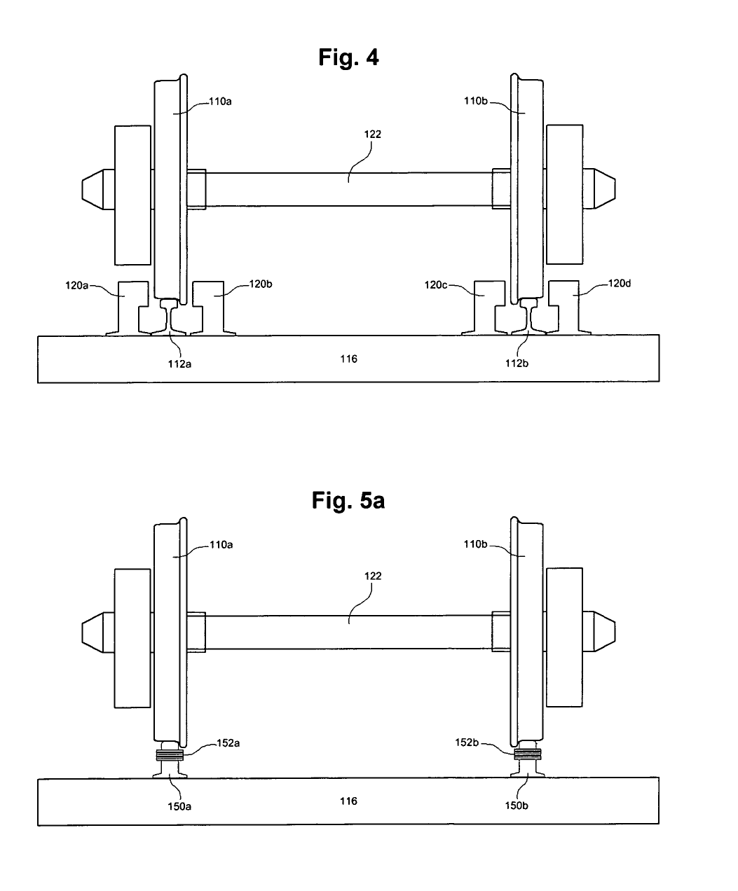

Multiple rail motors can be mounted on a single track, according to another embodiment of the present invention as shown in FIG. 4. This is an end view of railroad wheel set 122 with wheels 110a and b rolling on standard rails 112a and b over railroad ties 116. Rail motors 120a, b, c and d are mounted adjacent to rails 112a and b, both inside and outside of wheels 110a and b, to provide high thrust. An electrified track zone could include rail motors mounted on one, two, three or four sides of the rails, continuously or intermittently, to provide the magnitude of thrust required.

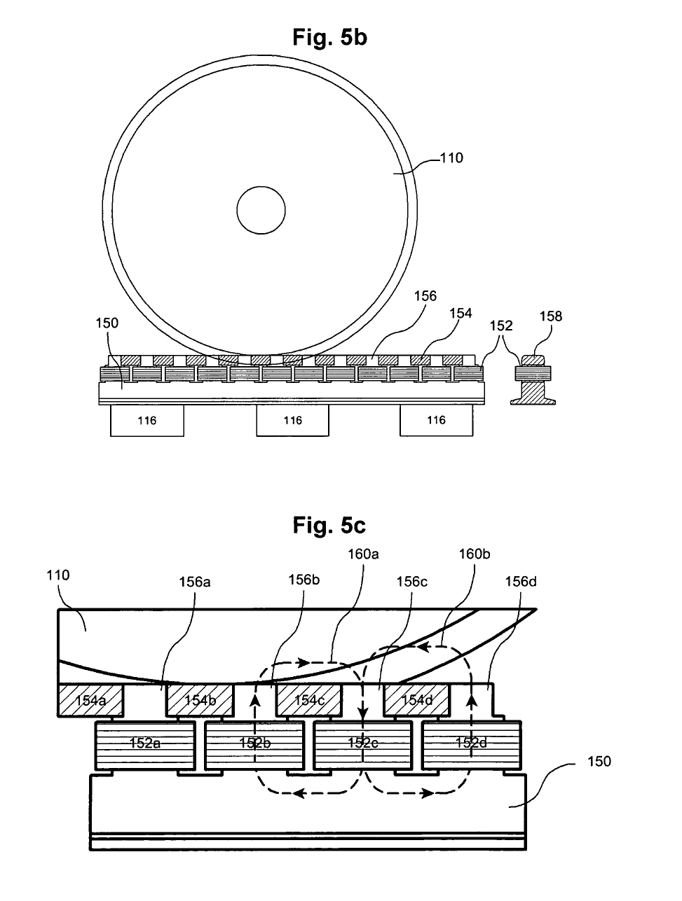

FIG. 5a is an end view of railroad wheel set 122 on modified rails 150a and b with rail motors according to an additional embodiment of the present invention. In this design, motor coils 152a and b are incorporated into rails 150a and b. FIG. 5b is a side view of the track. Motor coils 152 are wrapped around poles 156 that are integral to rail 150. Structural spacers 154, typically fabricated of a non-magnetic steel such as type 316 stainless steel, are welded or otherwise fastened between successive motor poles to provide a continuous running surface for wheel 110. A cross section 158 of rail 150 illustrates the rail profile.

FIG. 5c is a close-up side view of part of the modified track of FIG. 5a and 5b, showing wheel 110, motor poles 156a-d, structural spacers 154a-d, motor coils 152a-d, and rail 150. To provide thrust in the rightward direction, coil 152a is inactive. The motor control unit (not shown) drives current through coils 152b and 152c, with current circulating in opposite directions through the coils, to produce magnetic flux loop 160a. This flux loop attracts wheel 110 toward motor pole 156c, causing wheel 110 to roll forward (to the right). The motor control unit may also drive current through coil 152d, with the current direction opposite to coil 152c, producing flux loop 160b. This increases the attraction between wheel 110 and motor pole 156c and adds further attraction between wheel 110 and motor pole 156d, increasing thrust in the rightward direction. When wheel 110 has moved sufficient distance to make motor pole 156b ineffective, the control unit shuts off current to motor coil 152b and activates the next coil to the right of coil 152d (not shown). In this embodiment, the tangential force on the wheel is substantially directed down toward the rail. As with previous embodiments, this design can provide deceleration and/or regenerative braking in addition to acceleration.

Because of the small gap between wheel 110 and the active motor poles, rail motors of the type shown in FIG. 5a produce very high force. A basic rail motor design of this type was also evaluated using Finite Element Analysis, with the results indicating a thrust of 1600 Newtons for a 2-inch wide rail surface. This is a significant amount of thrust. For example, consider a typical train including 28 five-well platform stack cars (five cars connected in a single unit), with a total of 672 wheels, and four locomotives with another 48 wheels, for a total of 720 wheels. At 1600 N of thrust per wheel, the total tractive effort applied to the train by this rail motor is 1152 kilo-Newtons, which is considerably more than the maximum continuous tractive effort provided by a 6,000 hp line-haul locomotive at start-up (approximately 80 tons or 712 kN). In addition, the rail motor is not affected by ordinary adhesion factors such as weather or vehicle weight. Thrust is the same whether the rail is wet, icy, or dry.

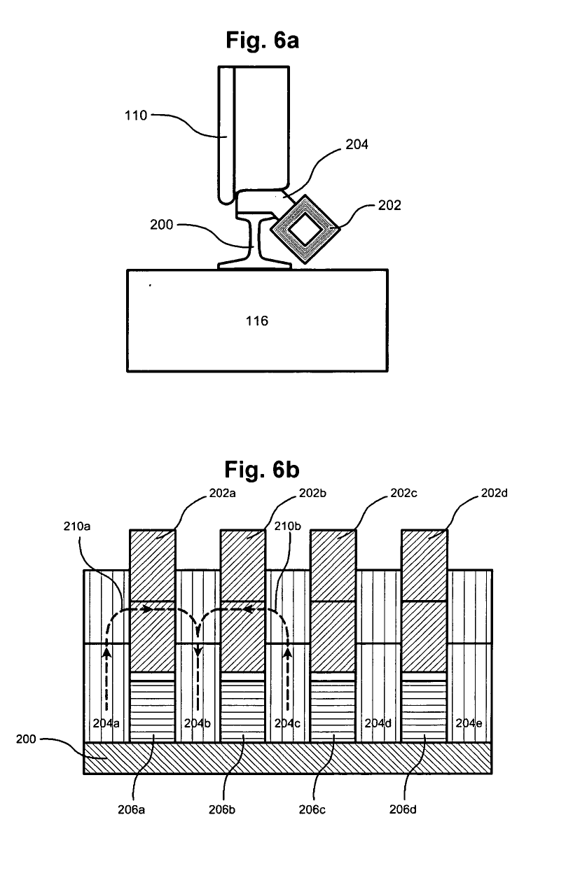

FIG. 6a shows a cross section of a track with wheel 110 riding on a rail that consist of nonmagnetic rail base 200, motor poles 204 and motor coils 202 according to a further embodiment of the present invention. FIG. 6b is a top view of this embodiment showing motor coils 202a-d, motor poles 204a-d, nonmagnetic structural spacers 206a-d and nonmagnetic rail base 200. Coils 202 are offset to the side of rail 200 and wrapped around the “U” shaped pole pieces. In operation, the motor control unit (not shown) drives current through motor coil 202a to produce flux loop 210a, which extends from motor pole 204a, through the center of coil 202a to motor pole 204b, upward through wheel 110 and back down to motor pole 204a where it closes the loop. The motor control unit may also drive current through motor coil 202b, circulating in the opposite direction from coil 202a, to produce flux loop 210b. This loop extends from motor pole 204c, through the center of coil 202b to motor pole 204b, upward through wheel 110 and back down to motor pole 204c again to close the loop. These flux loops act to attract wheel 110 down toward the motor poles, causing it to role forward with high thrust. Placing motor coils 202 to the side of rail 200 leaves no structural gaps. Motor poles 204 and structural spacers 206 provide a solid, continuous rolling surface for wheel 110. Again, this design can be used to provide deceleration and/or regenerative braking.

The rail motor drawings in the figures show simple, monolithic coils and magnetic poles for purposes of clarity, but other configurations are possible. Each electrical pole could be several iron segments long, with each gap then called a “slot”, and several slots per phase and per pole. “Fully pitched” windings would extend over several poles, and various lapped winding configurations are possible where the coils are distributed across several separate slots. Two, three and polyphase versions are all possible, as well as versions with overlapped or complex phasing such as turning on the coil directly under the wheel in the opposite polarity of the other coil(s) attracting the wheel.

Saturable iron bridges rather than non-magnetic steel spacers can be used in the gaps between motor cores. In this configuration some of the flux will short across the bridge, but the bridge can be thin enough to carry only a small percentage of the flux. The remainder of the flux will travel through the wheel to complete the motor circuit, as described above. Pole shoes could also be used to widen the motor cores where the flux exits the iron to cross the gap, and angled or shaped to modify operational characteristics.

Control of the rail motor, in any configuration, cannot rely upon the position of the train, or even individual vehicles, since the spacing of wheels will vary too much for precise control. To provide optimal timing of coil activation, the relative position of each wheel with respect to each coil must be determined. This can be accomplished using sensors of various types to detect wheel position, or by using the motor coils themselves as the sensing element. A low-level electrical current can be applied to each coil and used to measure inductance, which will change as the wheel passes. This can be used to precisely measure wheel position and determine the timing of current activation to each motor coil.

What is claimed is:

1. A system comprising:
at least one variable reluctance linear motor comprising an array of magnetic actuators arranged along at least a portion of a pathway,
at least one ferromagnetic rotating element, constrained to roll along the pathway about an axle; wherein,
the magnetic actuators are operated sequentially to impart at least partially a tangential force to the rotating element.

2. The system of claim 1, wherein the pathway is a railway, and the rotating element(s) are steel wheels of railway vehicles.

3. The system of claim 1 wherein the actuators are arranged whereby the tangential force is substantially along the pathway.

4. The system of claim 1 wherein the actuators are arranged whereby the tangential force is substantially toward the pathway.

5. A method for producing motion, comprising;
arranging at least one variable reluctance linear motor comprising an array of magnetic actuators along at least a portion of a pathway,
constraining at least one ferromagnetic rotating element to roll along the pathway about an axle; and,
operating the magnetic actuators sequentially to impart at least partially a tangential force to the rotating element.

6. The method of claim 5, wherein the pathway is a railway, and the rotating element(s) are steel wheels of railway vehicles.

7. The method of claim 5 wherein the actuators are arranged whereby the tangential force is substantially along the pathway.

8. The method of claim 5 wherein the actuators are arranged whereby the tangential force is substantially toward the pathway.
